(19) United States
(12) Patent Application Publication
(10) Pub. No.: US 2026/0064451 A1
(43) Pub. Date: Mar. 5, 2026

(54) STORAGE OFFLOAD OF VM MIGRATION ACROSS VIRTUALIZATION PLATFORM

(71) Applicant: Hitachi Vantara, Ltd., Yokohama-shi (JP)

(72) Inventors: Ryosuke TATSUMI, Sunnyvale, CA (US); Hiroyuki OSAKI, Los Gatos, CA (US); Paul MORRISSEY, Yokohama-shi (JP)

(21) Appl. No.: 18/821,713

(22) Filed: Aug. 30, 2024

(51) Int. Cl. G06F 9/455

(52) U.S. Cl. CPC G06F 9/45558; G06F 2009/4557; G06F 2009/45583

(57) ABSTRACT

Systems and methods involve obtaining a source identifier of a source volume to be migrated based on an execution of a process comprising transmitting an instruction to a virtual machine management system to request the source identifier of the source volume; obtaining a destination identifier of a destination volume; selecting a copy configuration based on parameters of the source volume identified by the source identifier and the destination volume identified by the destination identifier; and executing a copy operation on the source volume according to the copy configuration.

### BACKGROUND

### Field

The present disclosure is generally directed to storage systems and more specifically to virtual machine and/or volume migration across virtualization platforms

### Related Art

When Virtual Machine (VM) platform vendors get acquired by new entities, the license costs that can arise from the new entities can become unpredictable, and costs can suddenly rise. In such situations, the sudden increase in license costs accelerates the shift away from such VM platforms. Such customers may conduct an increased use of Kubernetes to run more productive IT services in a cloud-native environment, and use applications that allow existing VMs to run on Kubernetes without application modifications.

### SUMMARY

There are issues in the related art regarding the ability to apply migration from one virtualization platform to another. Existing VM migration tools transfer VM data from source logical device (LDEV) to target LDEV by server-based data copy technology. The server-based copy technology consumes network and sever resources and can be inefficient. In the related art, it is also not possible to use storage-based copy technology because the existing migration technology does not know the source LDEV and the storage array.

There is a need to reduce the amount of CPU and network resource consumption from offloading the data copy to the storage array.

Example implementations described herein related to a method and system for migrating virtual machines (VMs) and their associated virtual machine disks hosted on datastores into a native compatible volume format on the same storage platform without additional capacity requirements and without impacting existing business operations. Example implementations further provide a Kubernetes native way to create thin clone images of these disks and import those disks directly into Kubernetes as static persistent volumes and attached to VM pod(s), which allow the VM to operate without change on the target Kubernetes cluster.

Example implementations further involve a method for reducing the VM migration time and CPU/Network consumption during migration across the virtualization platform.

Example implementations further involve method and system for migrating virtual machines (VMs) and their associated datastores between source and destination servers in a networked computing environment. Such example implementations involve utilizing storage offload engines in destination servers, storage subsystems, and their copy technologies to efficiently transfer VM data while ensuring compatibility and minimal downtime during the migration process.

In example implementations, the storage offload engine is used to offload data transfer operations from the CPU to the storage subsystem, thereby improving migration efficiency and reducing the load on the main processor. The storage offload engine retrieves identifiers for volumes that are associated with the source and destination datastores, so as to request the storage subsystem to copy data between these volumes.

In example implementations, the storage offload engine also selects the copy technology based on the conditions provided in the copy technology list, ensuring that the appropriate method is used for data replication. This helps in optimizing the migration process by selecting the most suitable copy technology for the given storage environment.

Example implementations described herein can be utilized by industries who have legacy server virtualization platform and want to modernize to a newer virtualization platform. Such example implementations can be implemented on private cloud, including hybrid cloud environments, operating systems, and storage systems, as well as function as a storage management plug-in for VM migration, and can work in Kubernetes-based container orchestration environments.

In example implementations described herein, the storage offload engine also determines the data format of source datastores and destination datastores to ensure compatibility during the migration process. If the data formats are different, it triggers a data format conversion process to ensure seamless VM migration.

Example implementations also involve creating migration plans that specify the source and destination VMs, datastores, migration types (warm or cold), and storage offload settings. These plans are used to orchestrate the migration process, ensuring that VMs and their associated data are transferred accurately and efficiently.

Aspects of the present disclosure can include a method, which can involve obtaining a source identifier of a source volume to be migrated based on an execution of a process comprising transmitting an instruction to a virtual machine management system to request the source identifier of the source volume; obtaining a destination identifier of a destination volume; selecting a configuration based on parameters of the source volume identified by the source identifier and the destination volume identified by the destination identifier; and executing an operation on the source volume according to the configuration.

Aspects of the present disclosure can include a computer program, which can involve obtaining a source identifier of a source volume to be migrated based on an execution of a process comprising transmitting an instruction to a virtual machine management system to request the source identifier of the source volume; obtaining a destination identifier of a destination volume; selecting a configuration based on parameters of the source volume identified by the source identifier and the destination volume identified by the destination identifier; and executing an operation on the source volume according to the configuration. The computer program and instructions can be maintained on a non-transitory computer readable medium and executed by one or more processors.

Aspects of the present disclosure can include a system, which can involve means for obtaining a source identifier of a source volume to be migrated based on an execution of a process comprising transmitting an instruction to a virtual machine management system to request the source identifier of the source volume; means for obtaining a destination identifier of a destination volume; selecting a configuration based on parameters of the source volume identified by the source identifier and the destination volume identified by the destination identifier; and means for executing an operation on the source volume according to the configuration.

Aspects of the present disclosure can include an apparatus, which can involve a CPU configured to execute a method or instructions involving obtaining a source identifier of a source volume to be migrated based on an execution of a process comprising transmitting an instruction to a virtual machine management system to request the source identifier of the source volume; obtaining a destination identifier of a destination volume selecting a configuration based on parameters of the source volume identified by the source identifier and the destination volume identified by the destination identifier; and executing an operation on the source volume according to the configuration.

### BRIEF DESCRIPTION OF DRAWINGS

FIG. 1 illustrates a networked computing environment with multiple servers and a storage subsystem, in accordance with an example implementation.

FIG. 2 illustrates a networked computing environment focused on virtual machines (VMs) and data storage across source and destination servers, with an underlying storage subsystem, in accordance with an example implementation.

FIG. 3 illustrates a detailed view of the components and their roles in a virtualized environment involving source and destination servers, along with a storage subsystem, in accordance with an example implementation.

FIG. 4 illustrates an overview of the data tables and lists used in accordance with a first example implementation.

FIG. 5 illustrates a mapping between virtual machine (VM) IDs and their corresponding datastores, in accordance with an example implementation.

FIG. 6 illustrates detailed information about datastores, including their capacities, data formats, and associated storage and volume identifiers, in accordance with an example implementation.

FIG. 7 illustrates detail a migration plan for virtual machines (VMs) and their associated datastores between source and destination servers, in accordance with an example implementation.

FIG. 8 illustrates a mapping between virtual machine (VM) IDs and their corresponding datastores, in accordance with an example implementation.

FIG. 9 illustrates detailed information about datastores, including their capacities, data formats, and associated storage and volume identifiers, in accordance with an example implementation.

FIG. 10 illustrates information about different copy technologies and their associated conditions, in accordance with an example implementation.

FIG. 11 illustrates a flowchart detailing the process of Migration Controller to migrate a virtual machine (VM), in accordance with an example implementation.

FIG. 12 illustrates a flowchart detailing the process of Storage Offload Engine, in accordance with an example implementation.

FIG. 13 illustrates a flowchart of a variation of the process of Storage Offload Engine, in accordance with a second example implementation.

FIG. 14 illustrates a detailed view of the components and their roles in a virtualized environment involving source and destination servers, along with a storage subsystem, in accordance with an example implementation.

FIG. 15 illustrates detail a migration plan for virtual machines (VMs) and their associated datastores between source and destination servers in accordance with a third example implementation.

FIG. 16 represents a flowchart detailing the process of Migration Controller in accordance with a third example implementation.

FIG. 17 represents a flowchart of data-in-place migration engine which details the process for verifying, converting data formats if necessary, and managing virtual machine (VM) volumes during migration, in accordance with an example implementation.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means or can be implemented through a desired algorithm. Example implementations as described herein can be utilized either singularly or in combination and the functionality of the example implementations can be implemented through any means according to the desired implementations.

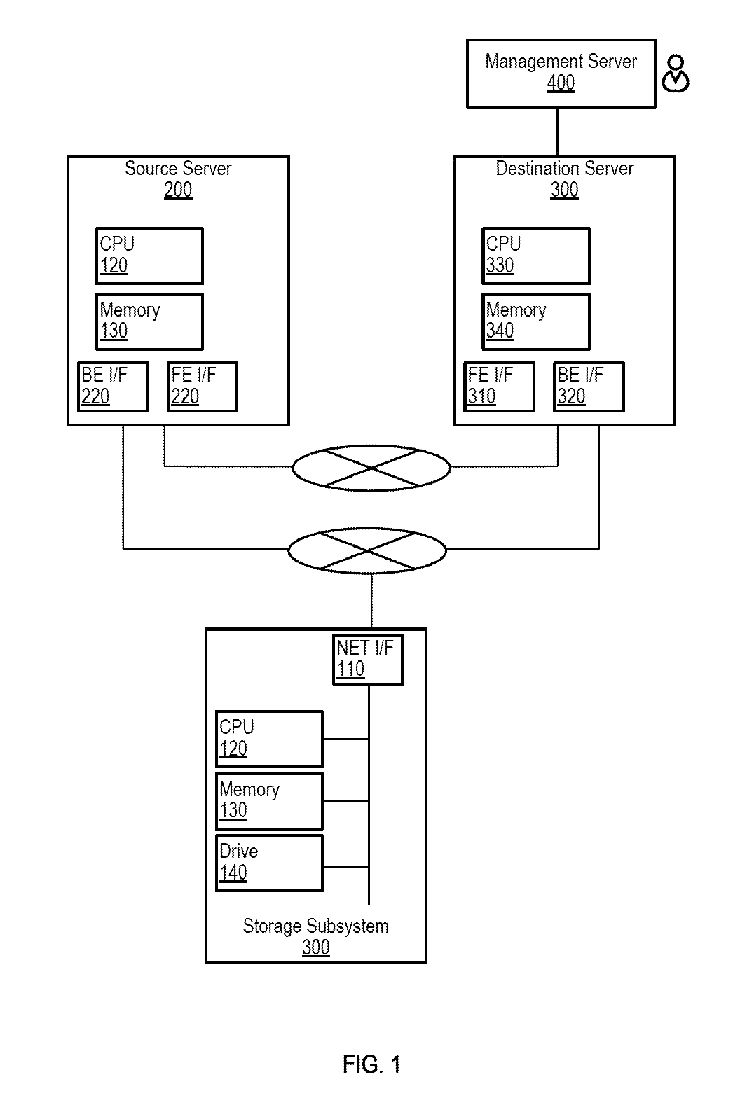

FIG. 1 illustrates a networked computing environment with multiple servers and a storage subsystem, in accordance with an example implementation. Source Server (200) and Destination Server (300) are connected via a network, indicated by the network symbols. The Storage Subsystem (100) is connected to the Source Server (200) and Destination Server (300) via its network interface (NET I/F 110). The Management Server (400) connects to Destination Server (300), as well as to other servers or network devices. The Source Server (200) and Destination Server (300) each include a central processing unit (CPU) (120, 330), memory (130, 340),front-end interface (FE I/F) (210, 310), and back-end interface (BE I/F) (220, 320). The Storage Subsystem (100) includes a CPU (120) memory (130),drive (140), and network interface (NET I/F) (110). The Management Server (400) may include similar components as the Source Server (200) and Destination Server (300), which has been omitted from this figure for clarity. The front-end interface (FE I/F) is typically used for client or network-facing connections, while the back-end interface (BE I/F) is used for internal connections, such as storage or other servers.

As illustrated in FIG. 1, Source Server (200) can involve CPU (120), which is the central processing unit that performs the computation tasks. Memory (130) can be in the form of Random Access Memory (RAM) which is used for temporary data storage and fast access. FE I/F (210) is a front-end interface for connecting to the network or other servers. BE I/F (220) is a back-end interface for connecting to storage or other backend systems.

As illustrated in FIG. 1, Destination Server (300) can involve CPU (330), which is the central processing unit that performs computation tasks. Memory (340) can be in the form of RAM which is used for temporary data storage and fast access. FE I/F (310) is the front-end interface for network or other server connections. BE I/F (320) is the back-end interface for connecting to storage or other backend systems.

As illustrated in FIG. 1, Storage Subsystem (100) can involve CPU (120), which is the central processing unit for managing storage operations. Memory (130) can be in the form of RAM which is used for storage management and fast access. Drive (140) involves the physical storage drives, such as Hard Disk Drives (HDDs) or Solid State Drives (SSDs), for persistent data storage. NET I/F (110) is the network interface for connecting to other servers or network devices.

As illustrated in FIG. 1, Management Server (400) is a server that is responsible for overseeing and managing the Destination Server (300). The management server (400) may connect to other servers or network devices.

The Source Server (200) and Destination Server (300) are connected via a network, as indicated by the network symbols. Further, the Storage Subsystem (100) is connected to the Source Server (200) via its network interface (NET I/F 110).

The Management Server (400) oversees the entire system, although some direct connections to other elements of FIG. 1 are omitted for clarity. Front-End Interface (FE I/F) is typically used for client or network-facing connections. Back-End Interface (BE I/F) is used for internal connections, such as storage or other servers.

This setup represents a VM migration system, where VM and the data from the Source Server is migrated to the Destination Server, with the Storage Subsystem providing the necessary persistent storage and the Management Server handling administrative tasks.

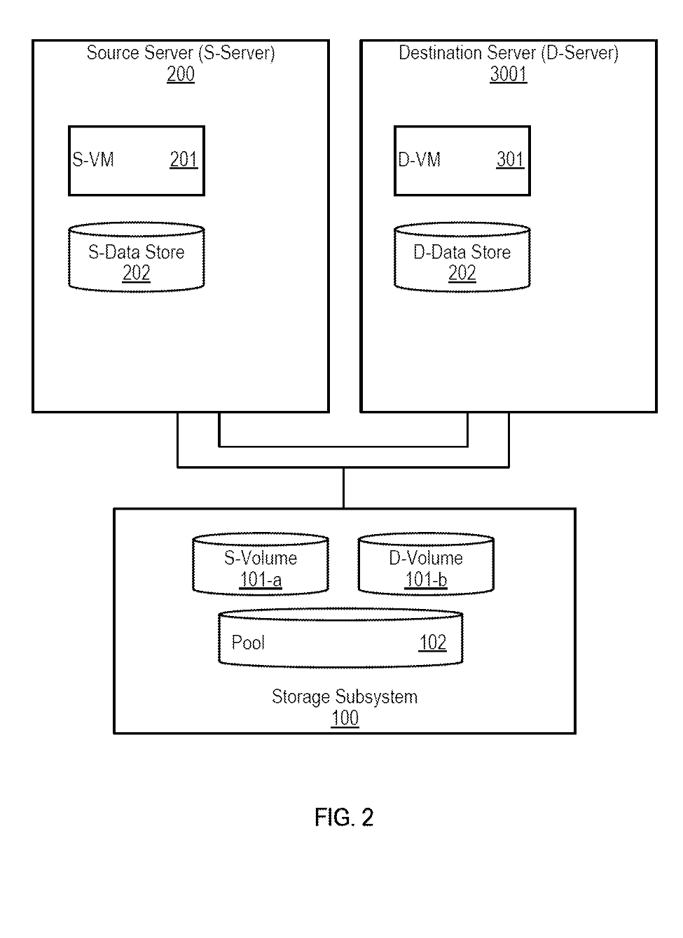

FIG. 2 illustrates a networked computing environment focused on virtual machines (VMs) and data storage across source and destination servers, with an underlying storage subsystem, in accordance with an example implementation.

Source Server (S-Server) 200 can include a S-VM (201), which is a virtual machine running on the Source Server. S-Datastore (202) is a datastore associated with the Source Server, used for storing data that the virtual machine or other applications need. A single S-Datastore may stores the data for multiple VMs.

Destination Server (D-Server) 300 can include D-VM (301), which is a virtual machine running on the Destination Server. D-Datastore (302) is a datastore associated with the Destination Server, used for storing data that the virtual machine or other applications need.

Storage Subsystem 100 includes S-Volume (101-a), which is a storage volume allocated to the Source Server. D-Volume (101-b) is a storage volume allocated to the Destination Server. Pool (102) is a storage pool from which the volumes (S-Volume and D-Volume) are allocated. This pool represents a collective storage resource from which space can be dynamically allocated as needed by the servers.

The Source Server (S-Server) 200 has a virtual machine (S-VM 201) and a datastore (S-Datastore 202), indicating that the VM uses the datastore for its operations. The Destination Server (D-Server) 300 has a virtual machine (D-VM 301) and a datastore (D-Datastore 302), indicating that this VM uses its associated datastore.

The Storage Subsystem 100 manages the underlying physical storage and provides storage volumes to both the Source and Destination Servers. S-Volume (101-a) and D-Volume (101-b) are specific allocations from the storage pool (102), dedicated to the Source and Destination Servers respectively. These volumes are used to store the data associated with the respective datastores (S-Datastore 202 and D-Datastore 302). This setup can represent a virtualized environment where data from the Source Server's VM and datastore are migrated to the Destination Server's VM and datastore with the Storage Subsystem that allocates volumes.

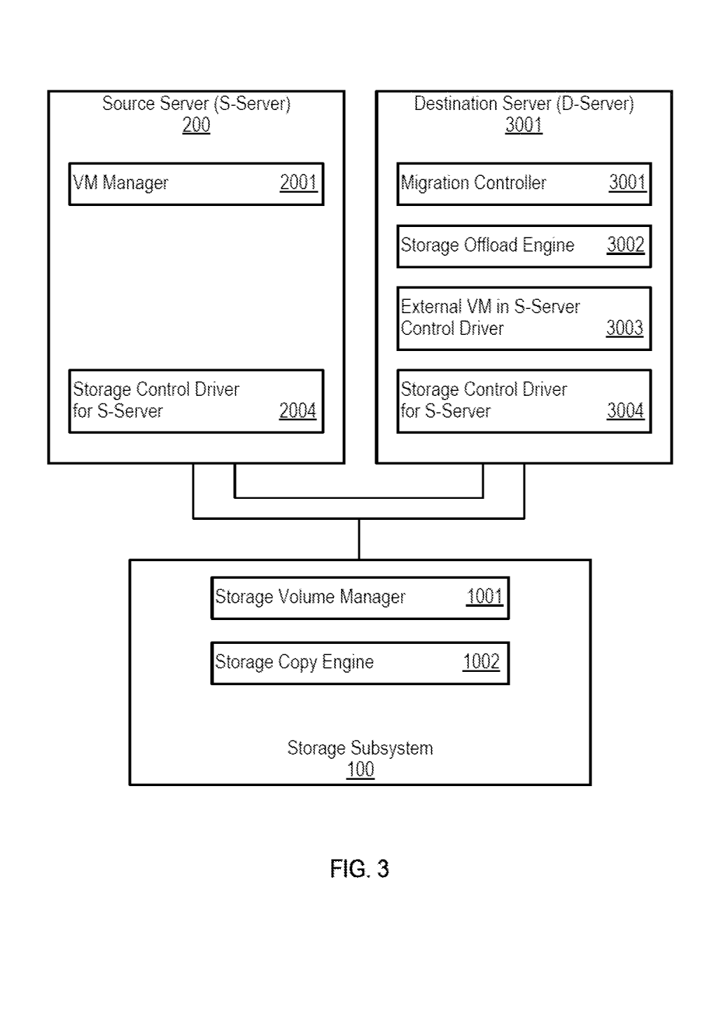

FIG. 3 illustrates a detailed view of the components and their roles in a virtualized environment involving source and destination servers, along with a storage subsystem, in accordance with an example implementation. The Source Server (200) includes the VM Manager (2001) and the Storage Control Driver (2004), while the Destination Server (300) includes the Migration Controller (3001), Storage Offload Engine (3002), External VM in S-Server Control Driver (3003), and Storage Control Driver (3004). The Storage Subsystem (100) can include the Storage Volume Manager (1001) and the Storage Copy Engine (1002).

Source Server (S-Server) (200) can involve the following elements. VM Manager (2001) manages the virtual machines on the Source Server, handling VM lifecycle tasks such as creation, deletion, and migration. VM Manager (2001) also manages the VMs configuration such as CPU, memory, and storage. Storage Control Driver for S-Server (2004) manages the interactions between the Source Server and the storage subsystem handling tasks such as I/O operations, volume mapping, and storage commands

Destination Server (D-Server) (300) can involve the following elements. Migration Controller (3001) oversees the migration of VMs and their data from the Source Server to the Destination Server. Storage Offload Engine (3002) offloads data transfer from the CPU to the storage subsystem to improve efficiency. External VM in S-Server Control Driver (3003) allows the Destination Server to manage and interact with VMs running on the Source Server for migration purposes Storage Control Driver for D-Server (3004) manages storage interactions for the Destination Server.

Storage Subsystem (100) can involve the following elements. Storage Volume Manager (1001) manages the management of storage volumes within the storage subsystem. Storage Copy Engine (1002) handles the copying and replication of data between storage volumes, ensuring data consistency and enabling features such as backups, snapshots, and data migration.

The VM Manager (2001) on the Source Server (200) manages the virtual machines and coordinates with the Migration Controller (3001) on the Destination Server (300) for VM migration using the External VM in S-Server Control Driver (3003). The Storage Control Drivers (2004 and 3004) on both servers handle the communication between their respective servers and the Storage Subsystem (100). The Storage Offload Engine (3002) on the Destination Server (300) improves VM migration efficiency by handling storage operations. The External VM in S-Server Control Driver (3003) on the Destination Server (300) interacts with VMs on the Source Server (200) for tasks of migrations. Within the Storage Subsystem (100), the Storage Volume Manager (1001) and Storage Copy Engine (1002) manage and replicate storage volumes ensuring efficient storage management across the environment.

The architecture illustrated in FIG. 3 represents an advanced virtualized environment with capabilities for VM migration, and improving efficiency of VM migration by storage offload.

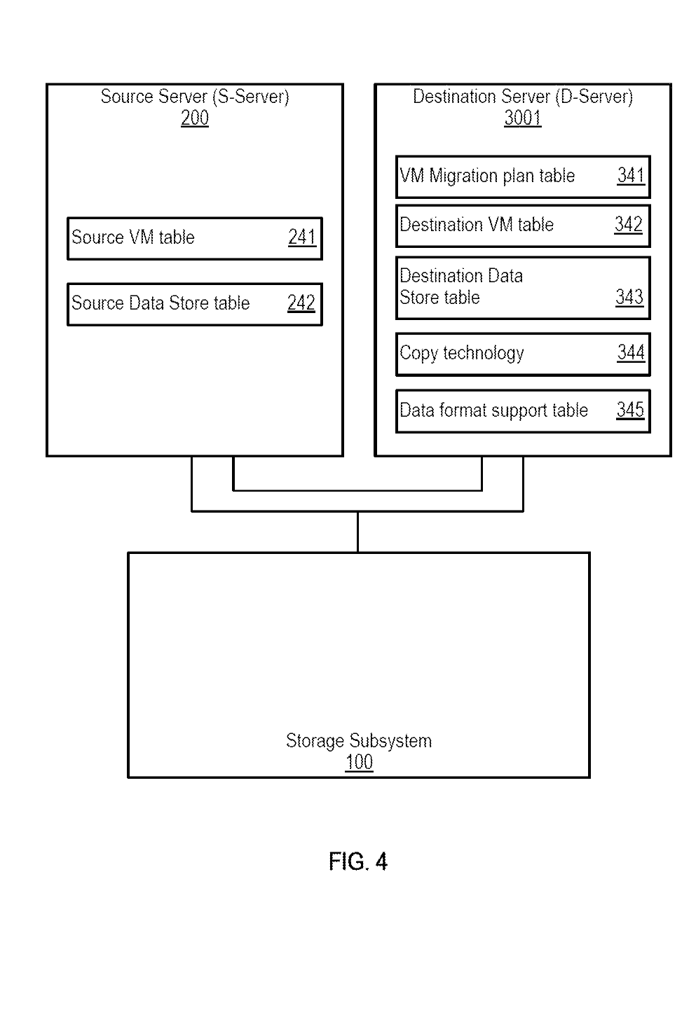

FIG. 4 illustrates an overview of the data tables and lists used in accordance with a first example implementation.

Source Server (S-Server) (200) can include the following. Source VM table (241) contains information about the virtual machines running on the Source Server. Source Datastore table (242) contains information about the datastores associated with the Source Server.

Destination Server (D-Server) 300 can include the following. VM Migration plan table 341 contains the plan for migrating VMs from the Source Server to the Destination Server. Destination VM table (342)contains information about the virtual machines that will be or have been migrated to the Destination Server. Destination Datastore table (343)contains information about the datastores associated with the Destination Server Copy technology list (344) contains information about the technologies used for copying data and the condition under which each technology can be applied in the Storage Subsystem. Data format support table (345) contains information about the data formats supported by the Destination Server.

The Source VM table (241) and Source Datastore table (242) on the Source Server (200) keep track of all relevant information about VMs and datastores on the Source Server. The VM Migration plan table (341) on the Destination Server (300) outlines the strategy and sequence for migrating VMs from the Source Server. The Destination VM table (342) and Destination Datastore table (343) on the Destination Server (300) tracks information about the VMs and datastores after they have been migrated. The Copy technology list (344) provides an overview of the tools and methods used to facilitate the migration process. The Data format support table (345) ensures that the Destination Server can properly handle and store the incoming data formats from the Source Server.

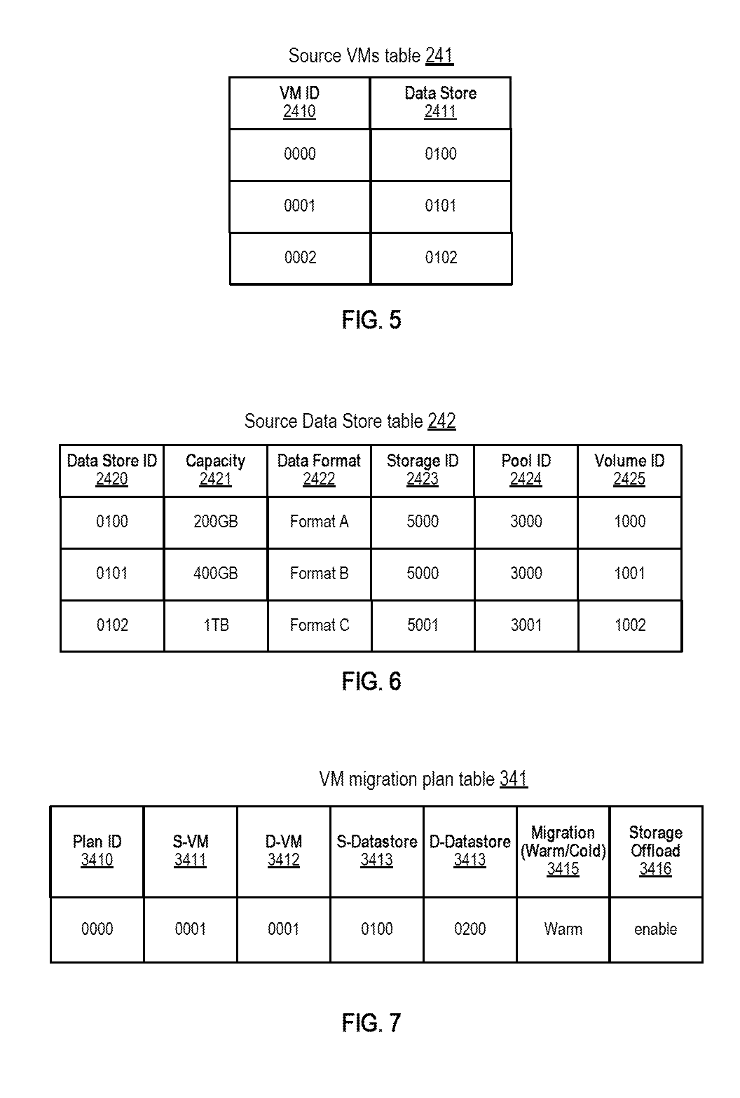

FIG. 5 illustrates a mapping between virtual machine (VM) IDs and their corresponding datastores, in accordance with an example implementation.

VM ID (2410) lists the unique identifiers for virtual machines. Each VM ID is a unique number assigned to a specific virtual machine within the system. The table shows three VM IDs: 0000, 0001,and 0002.Datastore (2411) lists the unique identifiers for datastores. Each datastore ID is associated with a specific VM and represents the storage location where the VM's data is kept. The table shows three datastore IDs: 0100, 0101, and 0102.

In the example of FIG. 5, VM ID 0000 is associated with Datastore 0100,which indicates that the virtual machine with ID 0000 uses the datastore with ID 0100. VM ID 0001 is associated with Datastore 0101,which indicates that the virtual machine with ID 0001 uses the datastore with ID 0101. VM ID 0002 is associated with Datastore 0102, which indicates that the virtual machine with ID 0002 uses the datastore with ID 0102.

This table (with VM ID 2410 and Datastore 2411 columns) is a mapping that helps in identifying which datastore is associated with which virtual machine. This can be useful for managing storage resources and ensuring that each VM's data is correctly allocated and accessible.

FIG. 6 illustrates detailed information about datastores including their capacities, data formats, and associated storage and volume identifiers, in accordance with an example implementation. Datastore ID (2420) lists the unique identifiers for datastores. Each datastore ID is a unique number assigned to a specific datastore. The table of FIG. 6 shows three datastore IDs: 0100, 0101, and 0102. Capacity (2421) lists the capacity of each datastore, indicating the amount of data it can hold. The capacities illustrated for FIG. 6 are: 200GB for datastore 0100, 400GB for datastore 0101, and 1TB for datastore 0102. Data Format (2422) lists the format in which data is stored in each datastore. The data formats illustrated in FIG. 6 are Format A for datastore 0100, Format B for datastore 0101, and Format C for datastore 0102. Storage ID (2423) lists the unique identifiers for storage subsystem that contains the datastores. The storage IDs illustrated for FIG. 6 are: 5000 for datastores 0100 and 0101, and 5001 for datastore 0102. Pool ID (2424) lists the unique identifiers for storage pools from which the datastores are allocated. The pool IDs illustrated for FIG. 6 are: 3000 for datastores 0100 and 0101, and 3001 for datastore 0102. Volume ID (2425) lists the unique identifiers for storage volumes associated with each datastore. The volume IDs illustrated in FIG. 6 are: 1000 for datastore 0100, 1001 for datastores 0101 and 1002 for datastores 0102.

FIG. 7 illustrates detail a migration plan for virtual machines (VMs) and their associated datastores between source and destination servers, in accordance with an example implementation. Plan ID (3410) lists the unique identifiers for migration plans. Each Plan ID represents a specific migration plan. The table of FIG. 7 shows one Plan ID 0000.S-VM (3411) lists the identifiers for source virtual machines that are part of the migration plan. The source VM ID listed for FIG. 7 is: 0001.D-VM (3412) lists the identifiers for destination virtual machines that will host the migrated VMs. The destination VM ID listed for FIG. 7 is 0001. S-Datastore (3413) lists the identifiers for source datastores associated with the VMs that are part of the migration plan. The source datastore ID listed for FIG. 7 is: 0100. D-Datastore (3414) lists the identifiers for destination datastores where the data from the source datastores will be migrated. The destination datastore ID listed for FIG. 7 is: 0200. Migration (Warm/Cold) (3415) specifies the type of migration being used. "Warm" migration indicates that the migration process is happening while the VM is still running but with minimal downtime, whereas "Cold" migration would mean the VM is completely powered off during the migration. The type of migration listed is: Warm. Storage Offload (3416) indicates whether storage offload functionality is enabled or disabled. Storage offload helps in offloading storage-related tasks from the main CPU to improve efficiency. The storage offload status listed is: enable,

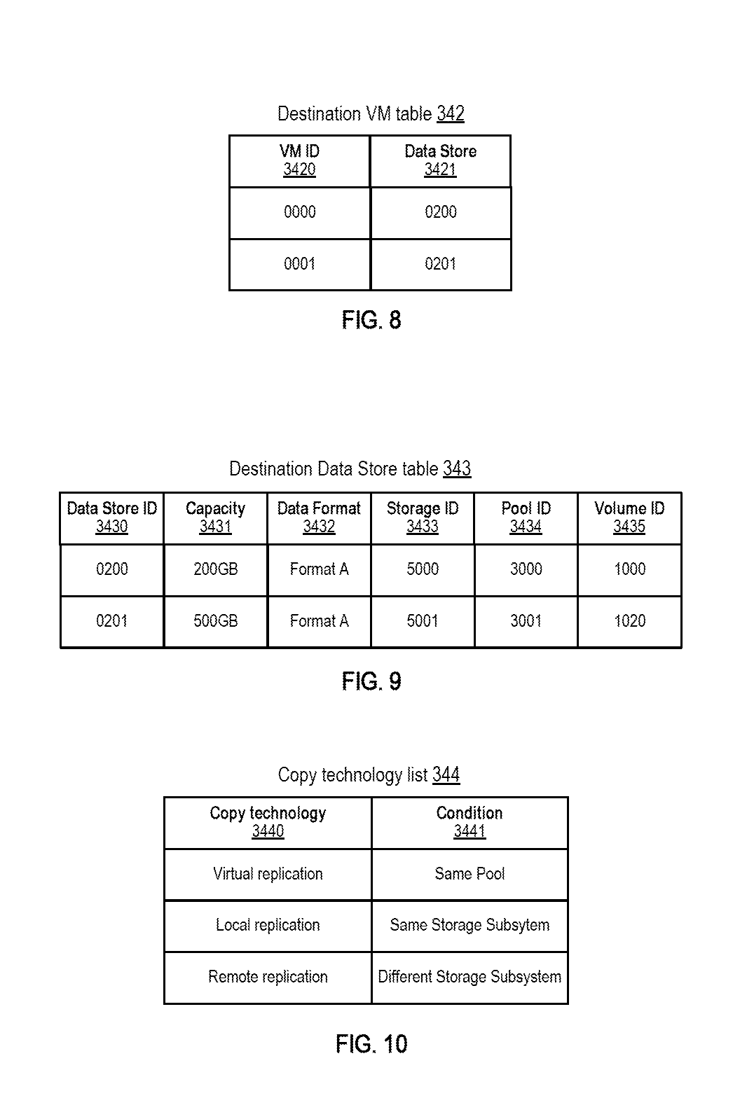

FIG. 8 illustrates a mapping between virtual machine (VM) IDs and their corresponding datastores, in accordance with an example implementation. VM ID (3420) lists the unique identifiers for virtual machines. Each VM ID is a unique number assigned to a specific virtual machine within the system. The table shows two VM IDs: 0000 and 0001.

Datastore (3421) lists the unique identifiers for datastores. Each datastore ID is associated with a specific VM and represents the storage location where the VM's data is kept. The table shows two datastore IDs: 0200 and 0201.

VM ID 0000 is associated with Datastore 0200, which indicates that the virtual machine with ID 0000 uses the datastore with ID 0200. VM ID 0001 is associated with Datastore 0201, which indicates that the virtual machine with ID 0001 uses the datastore with ID 0201.

FIG. 9 illustrates detailed information about datastores, including their capacities, data formats, and associated storage and volume identifiers, in accordance with an example implementation. Datastore ID (3430) lists the unique identifiers for datastores. Each datastore ID is a unique number assigned to a specific datastore. The table shows two datastore IDs: 0200 and 0201. Capacity (3431) lists the capacity of each datastore, indicating the amount of data it can hold. The capacities are 200GB for datastore 0200 and 500GB for datastore 0201. Data Format (3432) lists the format in which data is stored in each datastore. The data format for both datastores is: Format A. Storage ID (3433) lists the unique identifiers for storage units that house the datastores. The storage IDs are: 5000 for datastore 0200 and 5001 for datastore 0201. Pool ID (3434) lists the unique identifiers for storage pools from which the datastores are allocated. The pool IDs are: 3000 for datastore 0200 and 3001 for datastore 0201. Volume ID (3435) lists the unique identifiers for storage volumes associated with each datastore. The volume IDs are: 1010 for datastore 0200 and 1020 for datastore 0201.

This table provides a detailed plan for migrating a virtual machine and its datastore from a source to a destination server, including the type of migration and whether storage offload is used. This table is created by an administrator or migration tool to plan and execute the migration process.

FIG. 10 illustrates information about different copy technologies and their associated conditions, in accordance with an example implementation. Copy technology (3440) lists different technologies used for copying data. Each technology represents a specific method of data copy. The table shows three types of copy technologies: Virtual replication, Local replication, and Remote replication. Condition (3441) lists the conditions under which each copy technology is used. Each condition describes the environment or setup required for the corresponding replication technology. The table shows the following conditions: Same Pool, Same Storage Subsystem, and Different Storage Subsystem.

In the example of FIG. 10, there are three example types of replication. Virtual replication is used when the data is replicated within the same storage pool, indicating that the source and destination are within the same storage pool. Local replication is used when the data is replicated within the same storage subsystem, indicating that the source and destination are not within the same pool but part of the same storage subsystem. Remote replication is used when the data is replicated to a different storage subsystem, indicating that the source and destination are located in separate physical storage infrastructures, possibly in different geographic locations.

This table provides a comprehensive view of the various replication technologies and the specific conditions under which each technology is applicable, facilitating appropriate choices for data replication based on the storage environment and requirements. The copy technologies and conditions might vary based on the storage infrastructure.

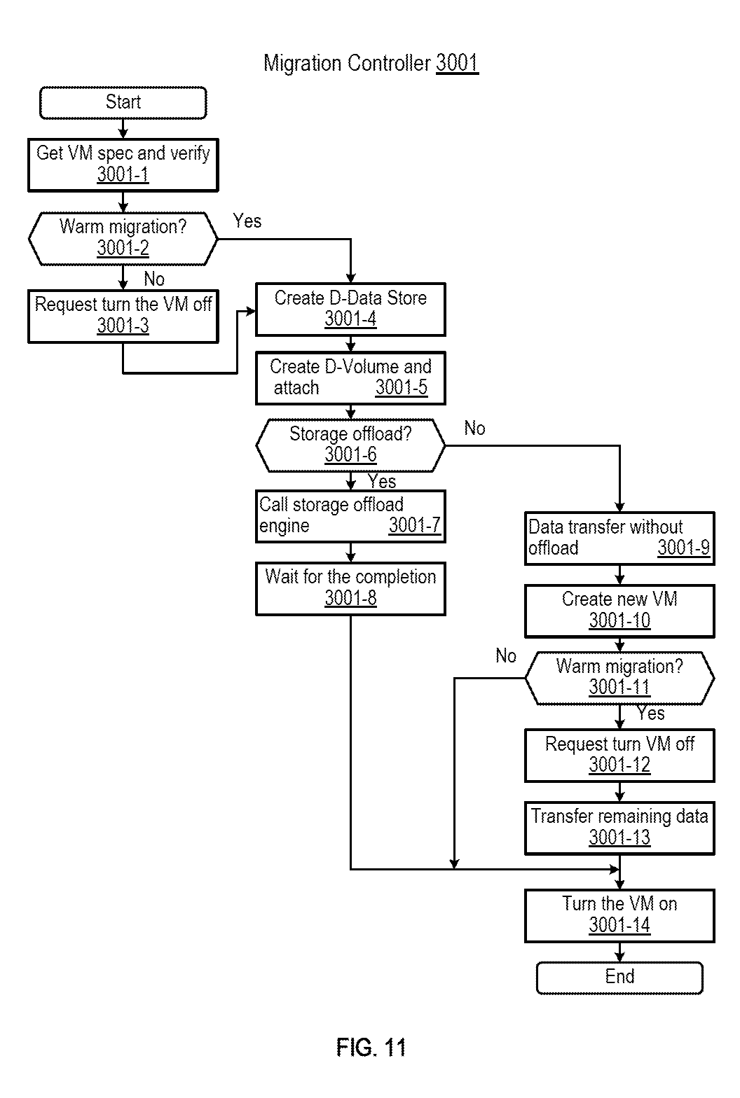

FIG. 11 illustrates a flowchart detailing the process of Migration Controller (3001) to migrate a virtual machine (VM), in accordance with an example implementation. This process starts when the Migration Controller receives a request to migrate a VM from the Source Server to the Destination Server.

At first the flow obtains the VM spec and verifies (3001-1). This step involves retrieving the specifications of the virtual machine as S-VM in the VM migration plan table (341) and verifying its detail spec to ensure it is able to migrate. Then a determination is made as to whether warm migration is conducted (3001-2). This decision point determines whether the migration will be a warm migration (where the VM remains running with minimal downtime) or not by checking the Migration type in the migration plan table (341). If Not (No), the flow then requests to turn the VM off (3001-3). If the migration is not a warm migration, this step involves requesting to turn off the Source VM to Source Server (200) to prepare it for migration.

Otherwise (Yes) or subsequently after (3001-3), the flow proceeds to create D-Datastore (3001-4). This step involves creating a datastore on the destination server where the Destination VM's data will be migrated.

After creating the datastore, the create D-Volume and attach step (3001-5) involves requesting creation of storage volume on the Storage Subsystem (100) and attaching it to the datastore. The Storage offload decision point (3001-6) determines whether storage offload is enabled from the migration plan table (341). If so (Yes), then the flow calls storage offload engine (3001-7), which involves invoking the storage offload engine to handle the data transfer. The wait for the completion (3001-8) step involves waiting for the data transfer to complete. This is relevant if storage offload is being used.

If storage offload is not enabled, the data transfer without offload (3001-9) step involves transferring the data without the assistance of the offload engine. After the data transfer is complete, the create new VM (3001-10) step involves creating a new virtual machine on the destination server using the migrated data.

The Warm migration decision point (3001-11) re-evaluates whether the migration process is a warm migration before proceeding VM cutover. If the VM is still running (Yes), the request turn VM off (3001-12) step involves requesting to turn off the Source VM. The transfer remaining data (3001-13) step involves transferring any remaining data of Source VM to ensure the Destination VM data is up to date with the Source VM data.

The final turn the VM on step (3001-14) involves turning on the Destination VM on the destination server.

As illustrated in FIG. 11, the process starts with retrieving and verifying the VM specifications. Depending on whether it is a warm migration or not, the VM may need to be turned off. The destination datastore and volume are then created and attached. Storage offload is checked and, if enabled, the offload engine is called to transfer data. Otherwise, data transfer is done without offload. After data transfer, a new VM is created on the destination server. The process re-evaluates the migration type and, if necessary, turns off the VM to transfer any remaining data. Finally, the VM is turned on at the destination.

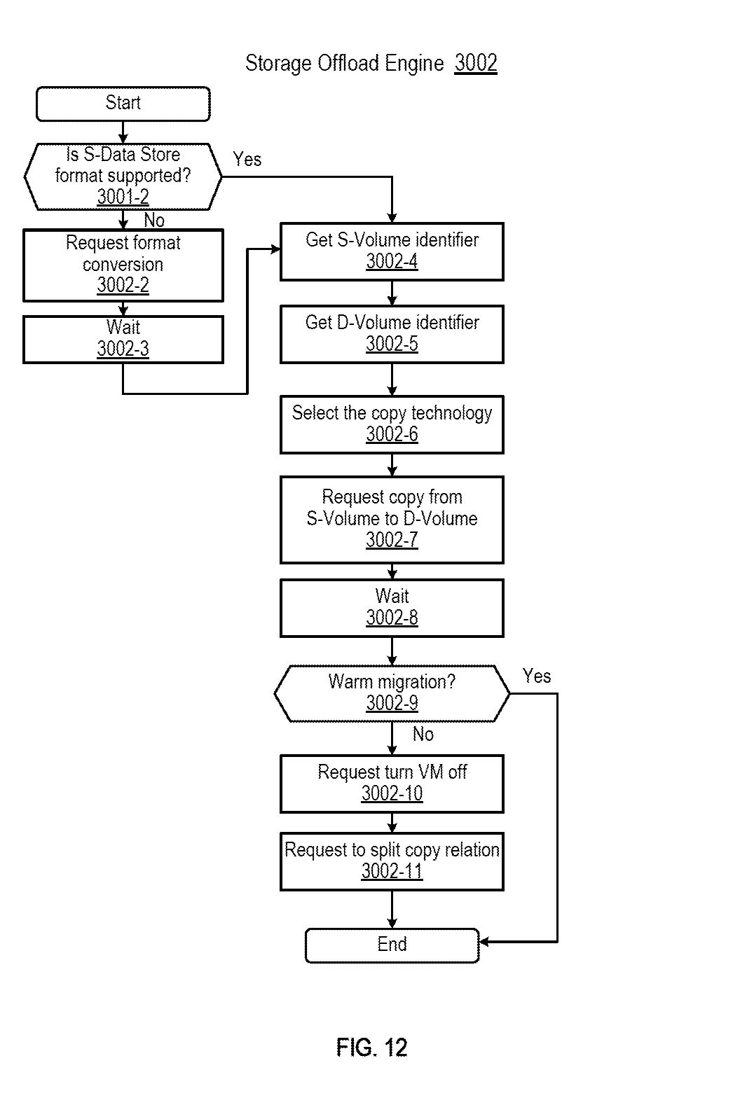

FIG. 12 illustrates a flowchart detailing the process of Storage Offload Engine (3002), in accordance with an example implementation. Each step in the process is numbered and includes specific actions or decisions. The S-Datastore format supported decision point (3002-1) checks whether the data format of the source datastore (S-Datastore) is supported by the destination server. Some format allows datastore to store the data of multiple VMs. In this case, the format conversion has to be done because the Destination Server doesn’t know which segment in the Volume the data of S-VM stores in. If the source datastore format is not supported (No), the request format conversion step (3002-2) involves requesting a format conversion to a supported format. One of those conversion tools is VMware Storage vMotion. The wait step 3002-3) involves waiting for the format conversion to complete.

The Get S-Volume identifier step (3002-4) involves retrieving the identifier of the source volume (S-Volume) that needs to be migrated. The get D-Volume identifier step (3002-5) involves retrieving the identifier of the destination volume (D-Volume) where the data will be migrated. The select the copy technology step (3002-6) involves selecting the appropriate copy technology for the data transfer, based on the requirements and conditions (e.g., local, remote, or virtual replication) The request copy from S-Volume to D-Volume step (3002-7) involves requesting data copy process to the Storage Subsystem from the source volume to the destination volume. The wait step (3002-8) involves waiting for the data copy process to complete and ensure that the S-Volume and D-Volume are synchronized. The copy process can be done in background or virtually instead of immediate full data copy. The warm migration decision point ? (3002-9) checks whether the migration is a warm migration, meaning the VM remains running with minimal downtime during the process.

If the migration is not a warm migration (No), the request turn VM off step (3002-10) involves requesting to turn off the virtual machine to finalize the migration. The request to split copy relation step (3002-11) involves requesting to split the copy relation between the source and destination volumes, finalizing the migration and ensuring the destination volume operates independently.

As illustrated in FIG. 12, the process starts with checking if the source datastore format is supported. If not supported, a format conversion is requested, and the process waits for its completion. The identifiers for the source and destination volumes are retrieved. The appropriate copy technology is selected, and the copy process is initiated. The process waits for the data copy to complete. Depending on whether it is a warm migration, the VM may be turned off. The copy relation is split, finalizing the migration process.

Example implementations also allow S-Volume to be directly assigned to D-Volume instead of copying data from S-Volume to D-Volume. In this case, a backup of the data in the S-Volume may be kept in another volume.

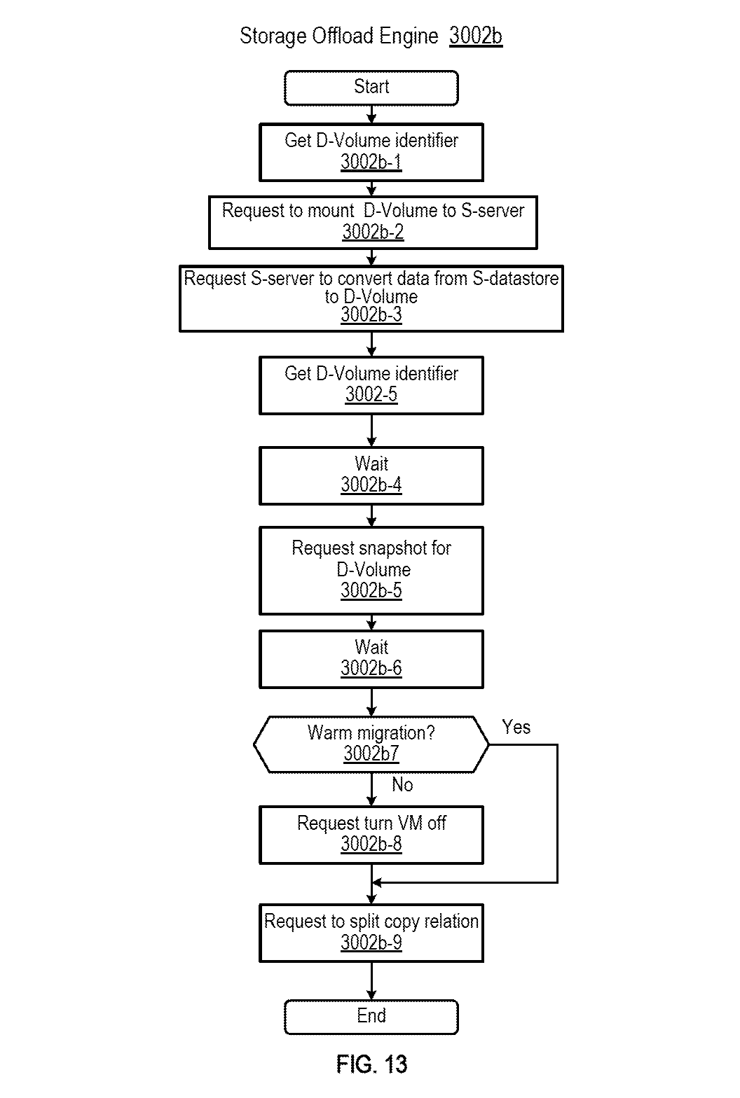

FIG. 13 illustrates a flowchart of a variation of the process of Storage Offload Engine (3002), in accordance with a second example implementation. This variation is using S-server's copy function and creating backup by using the storage array function.

The get D-Volume identifier step (3002b-1) involves retrieving the identifier of the destination volume (D-Volume) which was created in Migration Controller (3001). The request to attach D-Volume to S-server step (3002b-2) involves requesting to mount the D-Volume to the source server (S-server) to facilitate data transfer. The request S-server to convert data from S-datastore to D-Volume step (3002b-3) involves requesting the source server to convert the data from the source datastore (S-datastore) to the datastore mounted by destination volume (D-Volume). The wait step (3002b-4) involves waiting for the data conversion process to complete. The request snapshot for D-Volume step (3002b-5) involves requesting a snapshot of the destination volume to backup the data at the time of VM migration. The wait step (3002b-6) involves waiting for the snapshot process to complete.

The warm migration decision point (3002b-7) checks whether the migration is a warm migration meaning the VM remains running with minimal downtime during the process.

If the migration is not a warm migration (No), the request turn VM off step (3002b-8) involves requesting to turn off the virtual machine to finalize the migration. The request to split copy relation step (3002b-9) involves requesting to split the copy relation between the source and destination volumes, finalizing the migration and ensuring the destination volume operates independently.

As illustrated in FIG. 13, the process is a variation of the Storage Offload Engine (3002) process, where the destination volume is mounted to the source server for data transfer. The process starts with retrieving the destination volume identifier. The destination volume is mounted to the source server. Data conversion from the source datastore to the destination volume is requested. The process waits for the conversion to complete. A snapshot of the destination volume is requested and the process waits for its completion. Depending on whether it is a warm migration, the VM may be turned off. Finally, the copy relation is split, finalizing the migration process.

This flowchart ensures that all necessary steps and checks are followed for converting data and managing volumes during the migration of a virtual machine, whether it is done with minimal downtime (warm migration) or with the VM turned off.

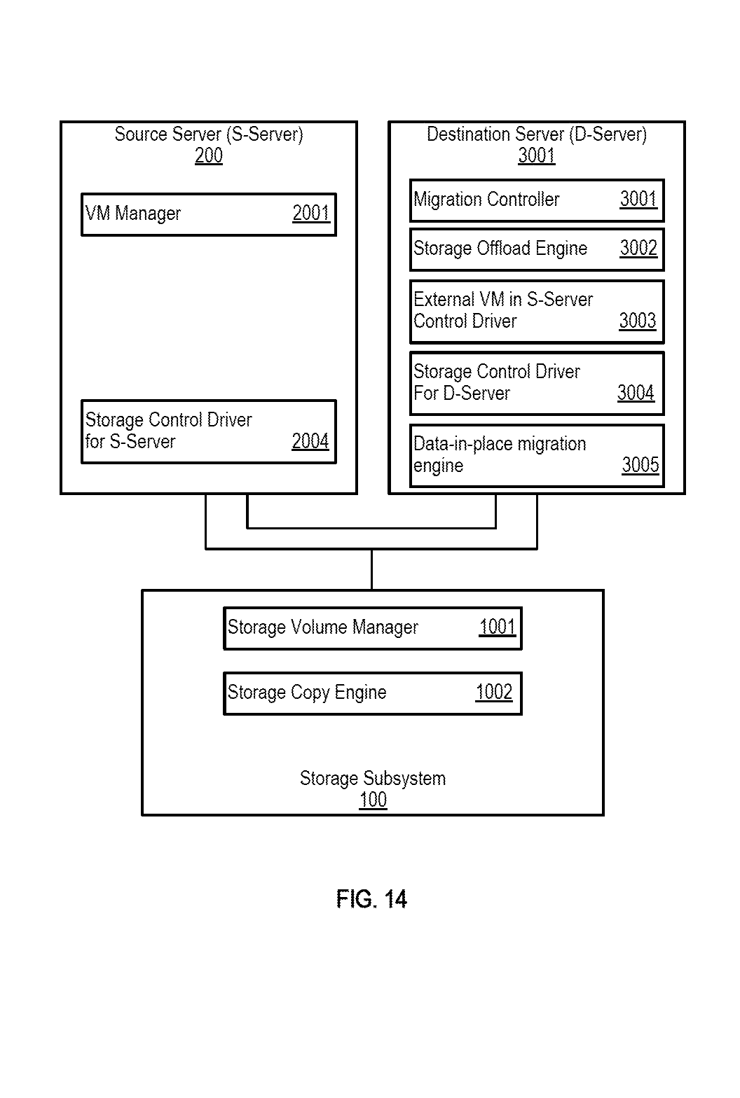

FIG. 14 illustrates a detailed view of the components and their roles in a virtualized environment involving source and destination servers, along with a storage subsystem, in accordance with an example implementation. The flow of FIG. 14 is similar to FIG. 3. The difference is that Data-in-place migration engine (3005) is added in the D-Server (300).

The Destination Server (D-Server) 300 can include Data-in-Place Migration Engine (3005), which attaches the S-Volume to D-Datastore in D-Server instead of actual data copy. The Data-in-Place Migration Engine (3005) on the Destination Server (300) improves VM migration efficiency by attaching the S-Volume to the D-Datastore when the data-in-place mode is requested.

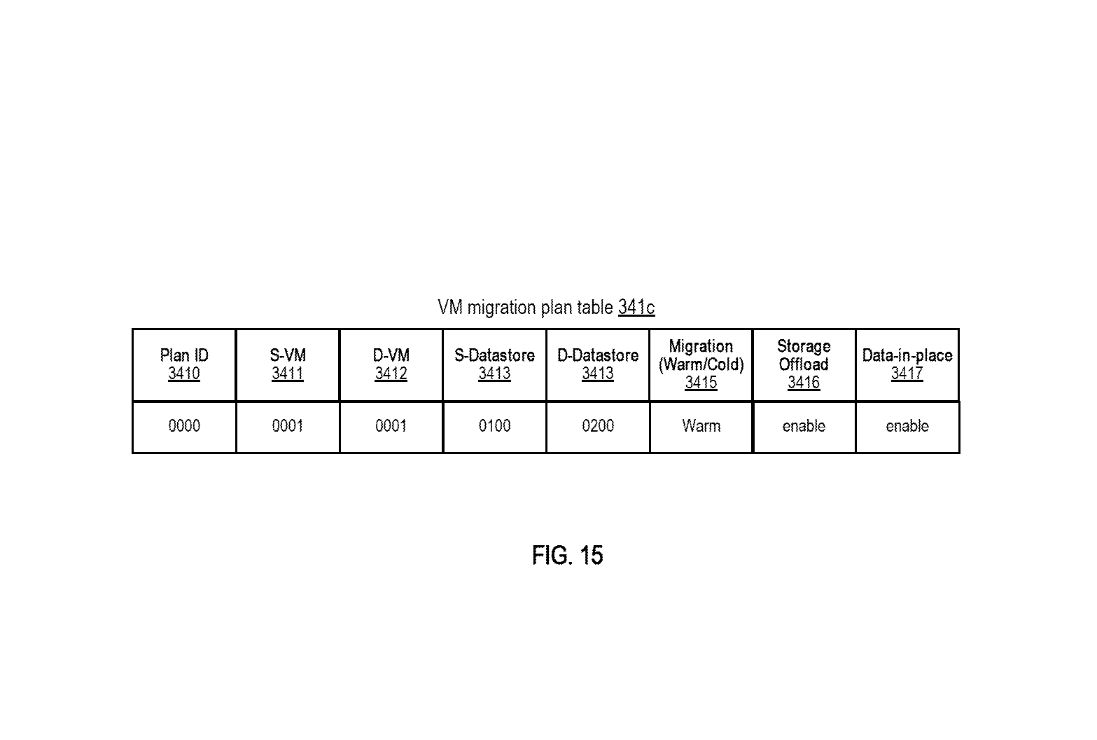

FIG. 15 illustrates detail a migration plan for virtual machines (VMs) and their associated datastores between source and destination servers in accordance with a third example implementation. FIG. 15 is similar to FIG. 7. The addition is the Data-in-Place (3417), which indicates whether data-in-place migration functionality is enabled or disabled. Data-in-Place migration helps in migrating VM by attaching the data associated S-Datastore to D-datastore directly. In the example of FIG. 15, the data-in-place status listed is: enable.

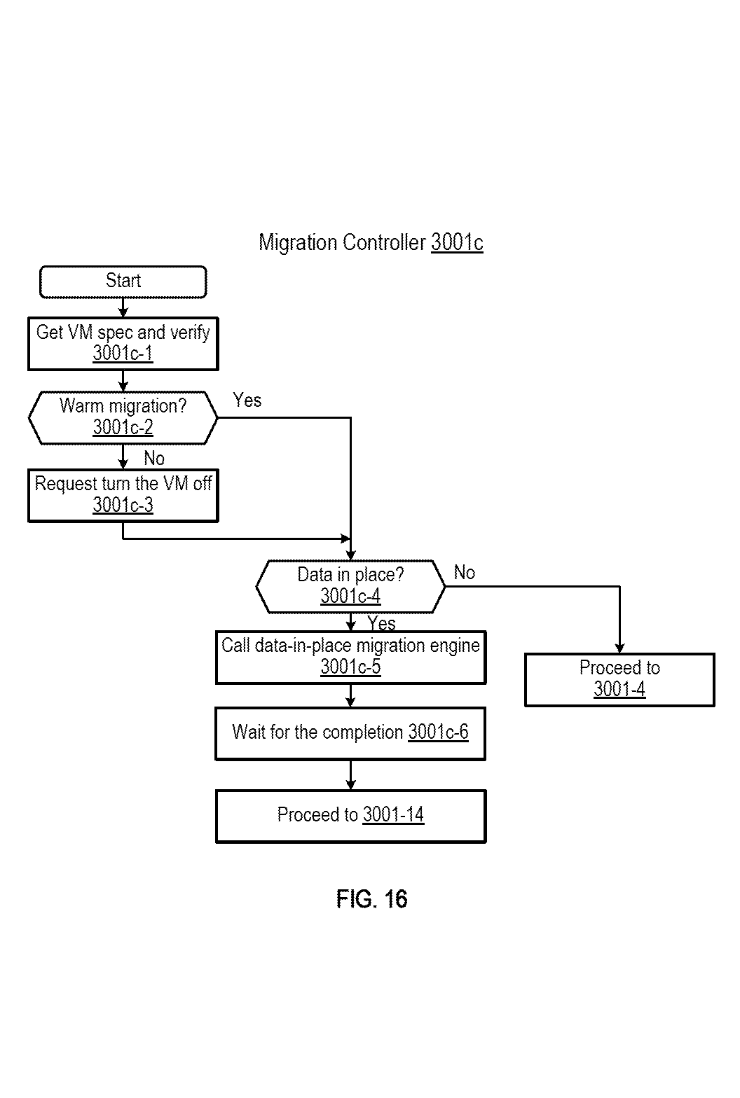

FIG. 16 represents a flowchart detailing the process 3001c of Migration Controller in accordance with a third example implementation. Here’s a detailed explanation of each numbered object: The get VM spec and verify step (3001c-1), warm migration decision point (3001c-2), and request turn the VM off step (3001c-3) are the same as FIG. 11.

The data in place decision point (3001c-4) determines whether data-in-place is enabled from the migration plan table (341c) If the data-in-place is set to enable (Yes), the all data-in-place migration engine step (3001c-5) involves calling a data-in-place migration engine to manage the data transfer appropriately. The migration controller (3001c) will then wait for the completion (3001c-6) of the data transfer before proceeding to the final turn the VM on step (3001-14).

If the data-in-place is not set to enable (No), the process follows the steps starting from the create D-Data store step (3001-4) from FIG. 11

As illustrated in FIG. 16, the process is almost same as FIG. 11. The decision point checks if the data-in-place is set to enable. If the data-in-place is set to enable, the data-in-place migration engine is called to handle the data transfer. If the data-in-place is not set to enable, the process follows the steps starting from "Create D-Data Store (3001-4)" as detailed in the flowchart of FIG. 11. This flowchart provides an alternative approach to the migration process by introducing data-in-place migration, which can be more efficient in certain scenarios where data does not need to be moved physically to the destination volume.

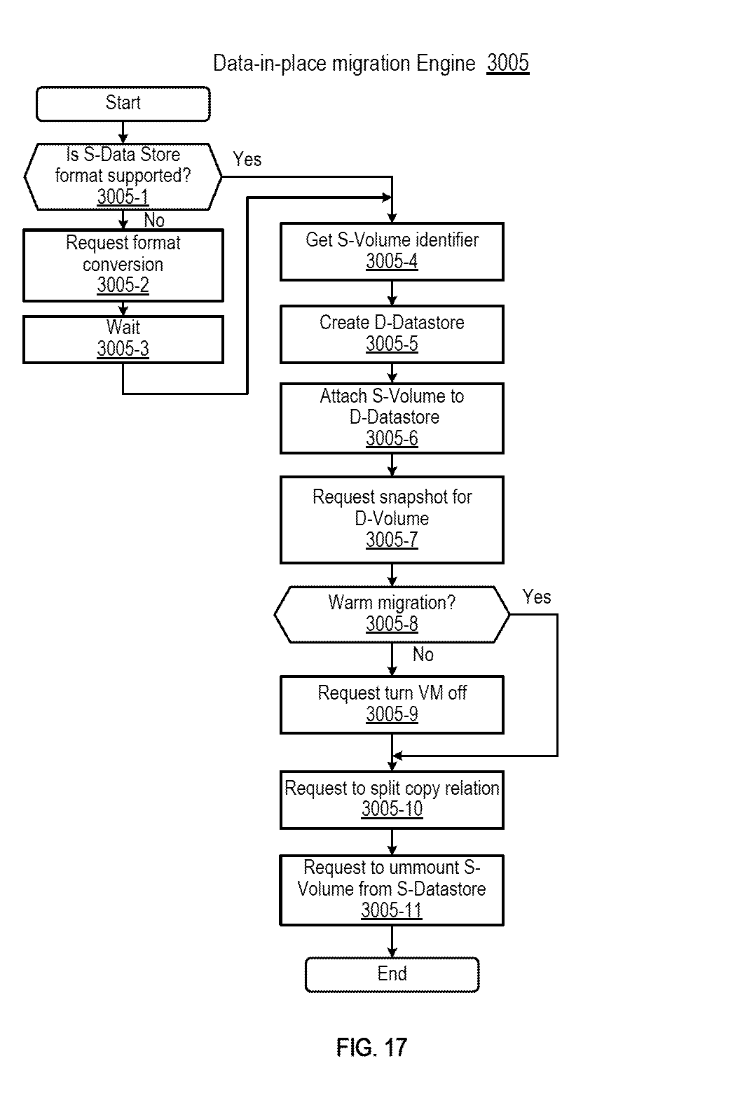

FIG. 17 represents a flowchart of data-in-place migration engine (3005) which details the process for verifying, converting data formats if necessary, and managing virtual machine (VM) volumes during migration, in accordance with an example implementation. The S-Datastore format supported decision point (3005-1), request format conversion step (3005-2), wait step (3005-3), and get S-Volume identifier step (3005-4) follow the flow as 3002-1 to 3002-4. The create D-Datastore step (3005-5) involves creating a data store on the destination server D-Datastore where the VM's data will be migrated. After creating the destination datastore, the attach S-Volume to D-Datastore step (3005-6) involves attaching the source volume to the destination datastore. If the format conversion was done, S-Volume means the volume that has the converted data. The request snapshot for S-Volume step (3005-7) involves requesting a snapshot of the source volume (S-Volume) to preserve the data at the time of migration. The warm migration decision point (3005-8) checks whether the migration, is a warm migration meaning the VM remains running with minimal downtime during the process.

If the migration is not a warm migration (No), the request turn VM off step (3005-9) involves requesting to turn off the virtual machine to finalize the migration. The request to split copy relation step (3005-10) involves requesting to split the copy relation between the source volume and its snapshot, finalizing the migration and ensuring the volume operates independently.

The request to unmount S-Volume from S-Datastore step (3005-11) involves requesting to unmount the source volume from the source datastore after the migration is complete.

As illustrated in FIG. 17, the process starts with checking if the source datastore format is supported. If not supported, a format conversion is requested and the process waits for its completion. The identifier for the source volume is retrieved. The destination datastore is created and the source volume is attached to it directly. A snapshot of the source volume is requested and the process waits for its completion. Depending on whether it is a warm migration, the VM may be turned off. The copy relation is split. Finally, the source volume is unmounted from the source datastore after the migration is complete.

Through the example implementations described herein efficient data migration can be facilitated. The example implementations provide a structured approach to migrating virtual machines and their associated datastores, ensuring efficient and reliable data transfer between servers by utilizing storage offload engines and copy technologies.

Through the example implementations described herein, storage optimization can be facilitated. By utilizing storage offload engines and copy technologies, the example implementations optimize data transfer processes, reducing the load on the main CPU and improving overall system performance.

Through the example implementations described herein, data format compatibility can be facilitated. The example implementations address data format compatibility issues, ensuring that data can be migrated even if the source and destination servers have different data formats.

Through the example implementations described herein downtime can be reduced. For the warm migration, the example implementations facilitate the reduction of VM downtime during the migration process by using storage-based relation split process instead of transferring remaining data process between source and destination servers.

Through the example implementations described herein, automated migration can be facilitated. The flowcharts provide a clear and automated process for migrating virtual machines and their datastores, reducing manual intervention and potential errors in the migration process.

Through the example implementations described herein, redundancy can be facilitated. The example implementations ensure ensures that data is synchronized between source and destination volumes and the source data is remained intact until the administrator confirms the data can be deleted. It allows to go failback process if the migration is failed.

Further, the example implementations can be extended to support multiple source and destination servers, enabling complex migration scenarios involving multiple servers and datastores. The example implementations also allows S-Volume to be directly assigned to D-Volume instead of copying data from S-Volume to D-Volume. In this case a backup of the data in the S-Volume may be kept in another volume.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system’s registers and memories into other data similarly represented as physical quantities within the computer system’s memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
obtaining a source identifier of a source volume to be migrated based on an execution of a process comprising transmitting an instruction to a virtual machine management system to request the source identifier of the source volume;
obtaining a destination identifier of a destination volume;
selecting a configuration based on parameters of the source volume identified by the source identifier and the destination volume identified by the destination identifier; and
executing an operation on the source volume according to the configuration.

2. The method of claim 1, wherein the instruction comprises one of an Application Programming Interface (API) call to the virtual machine management system, or an instruction transmitted through Secure Shell Protocol (SSH).

3. The method of claim 1, wherein the process further comprises receiving, in response to the instruction, the source identifier of the source volume.

4. The method of claim 3, wherein the configuration comprises assigning the destination volume identified by the destination identifier as a primary volume after snapshot of the source volume identified in the source identifier is provided to the destination volume, wherein the operation is a copy operation.

5. The method of claim 3, wherein the configuration comprises assigning the source volume identified by the source identifier as the destination volume, wherein the operation comprises maintaining the assignment.

6. The method of claim 1, wherein the process comprises:
extracting source virtual machine data to a new volume as the source volume;
for a data storage type of the source virtual machine data not being supported by the destination volume, executing data conversion on the source virtual machine data to a supported format; and
extracting the source identifier based on the data storage type of the source volume.

7. The method of claim 6, wherein the copy configuration comprises assigning the destination volume identified by the destination identifier as a primary volume after snapshot of the source volume identified in the source identifier is provided to the destination volume.

8. The method of claim 6, wherein the copy configuration comprises assigning the source volume identified by the source identifier as a primary volume after snapshot of the source volume identified in the source identifier is provided to the destination volume.

9. The method of claim 1, wherein the obtaining a destination identifier of a destination volume is conducted from a path dynamically allocated from a forklift process.
